(19) United States
(12) Patent Application Publication
(10) Pub. No.: US 2006/0100911 A1
(43) Pub. Date: May 11, 2006

(54) Health insurance for their own employees at and by companies, manufacturers, enterprises, organizations, agencies

(76) Inventor: Henri Duong, Whitehall, OH (US)

Correspondence Address: Henri Duong, Apt A 2630 Delta Ave, Rosemead, CA, 91770, US

(21) Appl. No.: 10/359,111

(22) Filed: Feb. 5, 2003

(51) Int. Cl. G06Q 40/00

(52) U.S. Cl. 705/4

(57) ABSTRACT

Health insurance enterprising policy leads to increase an additional income channel from their own employees at and by enterprises, manufacturers, companies, organizations, agencies besides their original business lines. It simplifies business network to be a project of neither investment capital nor competitor to benefit enterprises in their developing fields at a long term.

### CROSS-REFERENCE TO RELATED APPLICATIONS

Disclosure Document Deposit Request; Disclosure Document No: 503810 date: Jan. 18, 2002 PTO-1652 (8/99)

### STATEMENT REGARDING FEDERALLY SPONSORED RESEARCH

“Not Applicable”

### REFERENCE TO A MICROFICHE APPENDIX

“Not Applicable”

### BACKGROUND OF THE INVENTION

Manufacturer is a source of power creates immense jobs for employees to promote progress of a society. FIG. 2: Enterprises, companies, manufacturers, organizations, agencies. ought handle Health insurance line for their own employees as their business to increase a new activity besides current income line thus improving financial standing to reinforce their capitals 5 in new investments but they do not handle such a system by themselves.

The inventive theory is to create extra profits of neither investment capital nor business competitors with their own employees.

### BRIEF SUMMARY OF THE INVENTION

Enterprises stand at sphere to maintain considerable jobs for employees to progress a society while FIG. 5: Health insurance enterprising policies assure at enterprises to support better financial standings by employees to develop in business groups.

The advantage of the inventive theory leads to increase an additional income channel from their own employees at and by enterprises, manufacturers, companies, organizations, agencies besides their original business lines.

The system includes Health insurance enterprising policy, function of the system at and by enterprises, manufacturers, companies, organizations, agencies with their own employees.

### BRIEF DESCRIPTION OF THE DRAWINGS

FIG. 1; Health insurance enterprising department network.

FIG. 2; Income profits in two periods.

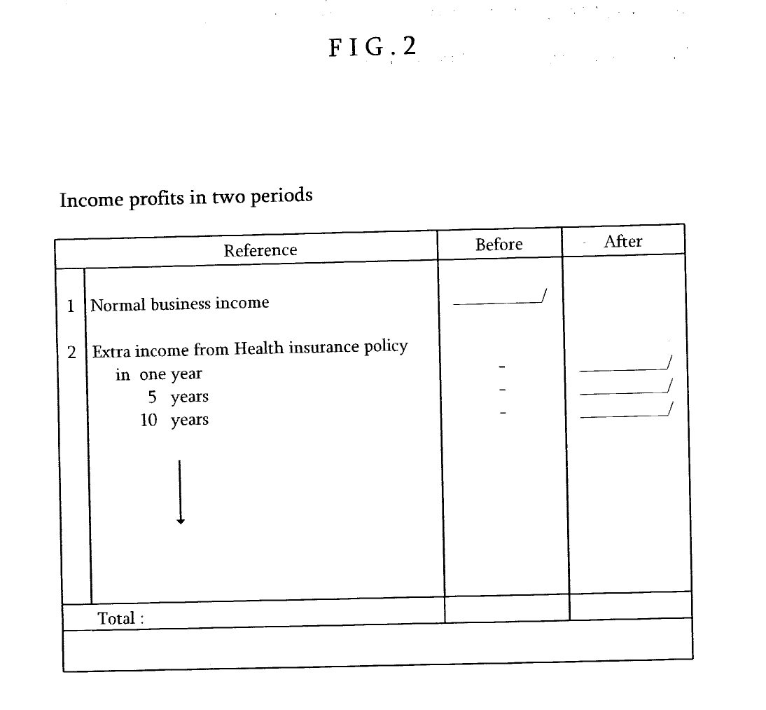

FIG. 3; List of reference in estimation.

FIG. 4; Collective insurance office for small companies.

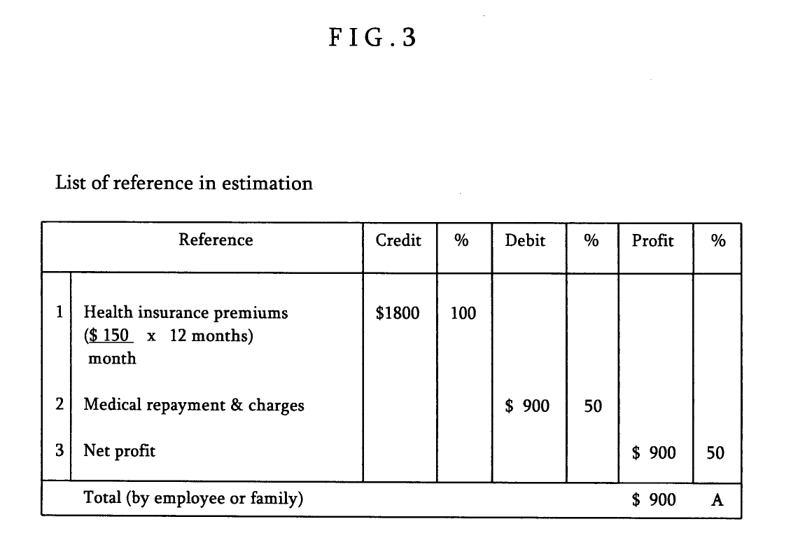

FIG. 5; Profits are from zero-point (assessment table).

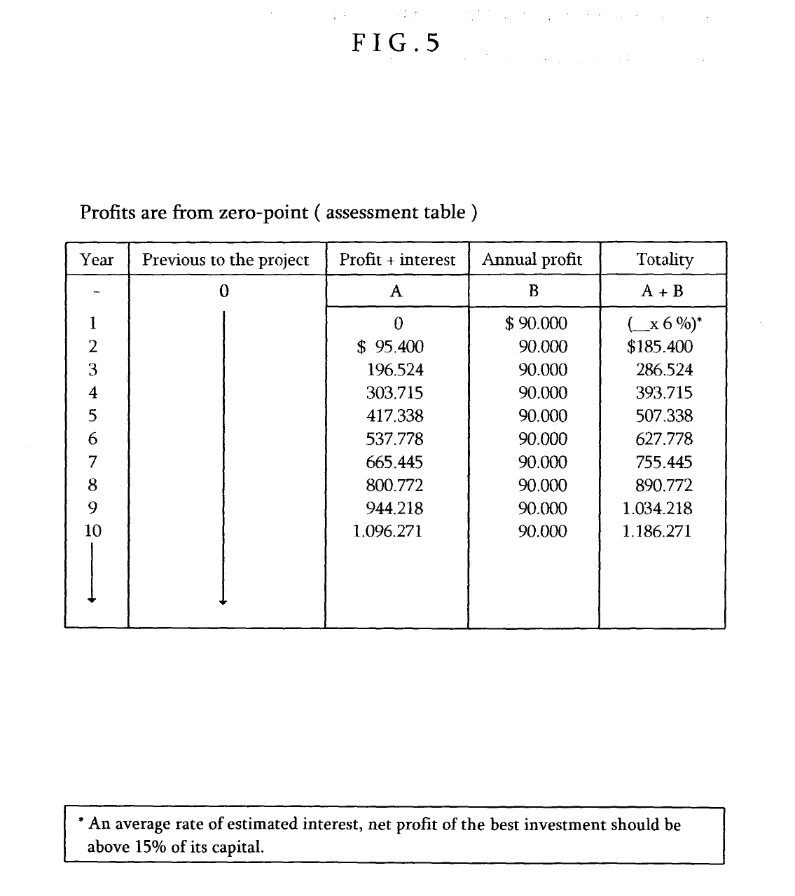

FIG. 6; Employee's Insurance Status.

FIG. 7; Multiplication on income.

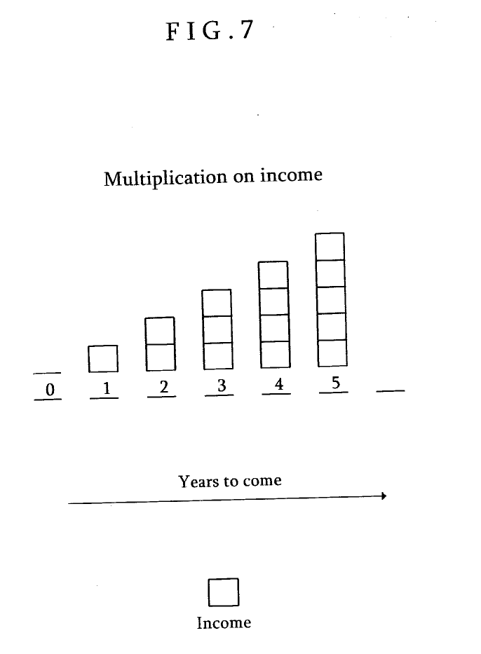

FIG. 8; Business without competition.

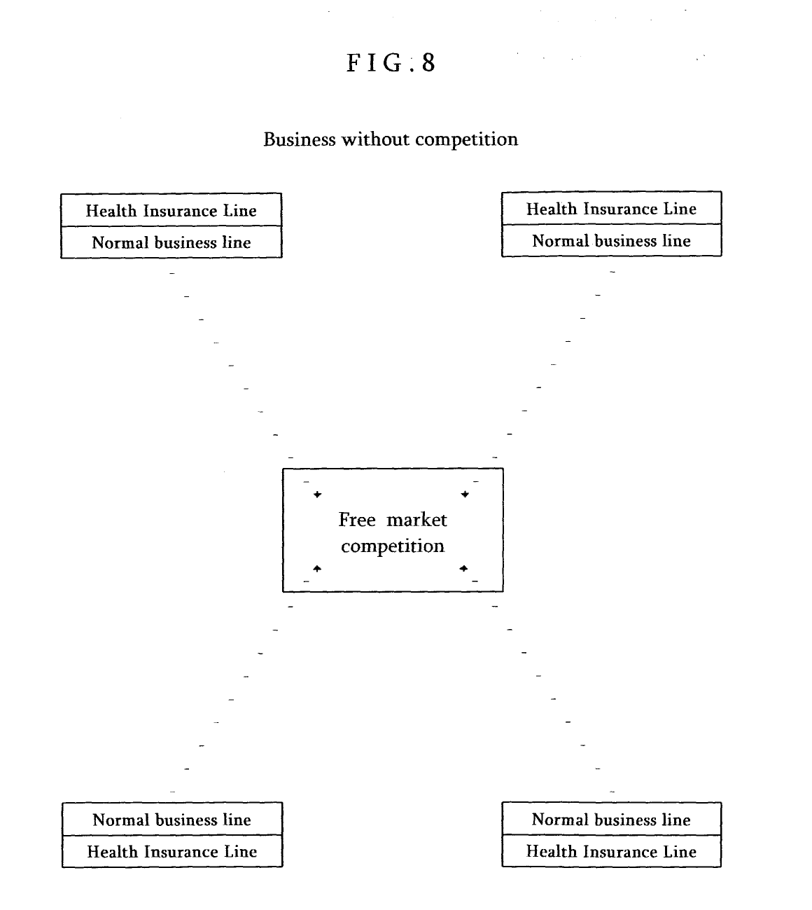

FIG. 9; A group of economic power in commercial expansion.

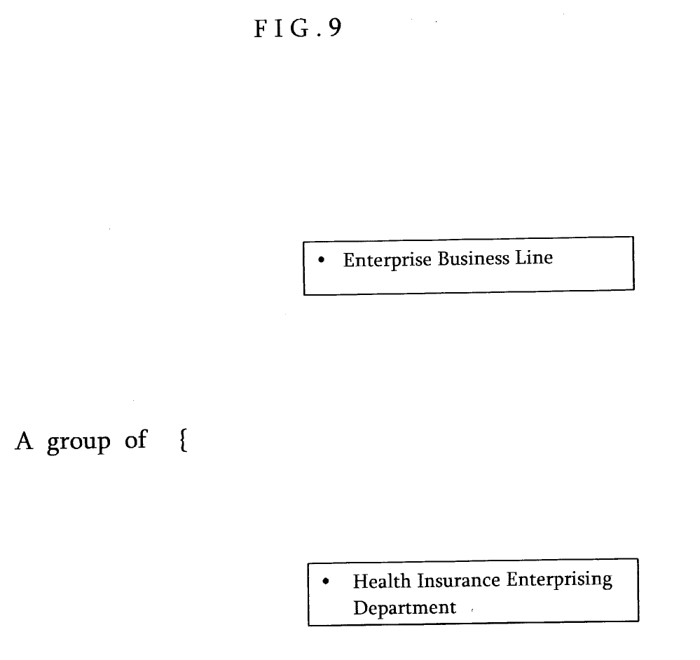

### DETAILED DESCRIPTION OF THE INVENTION

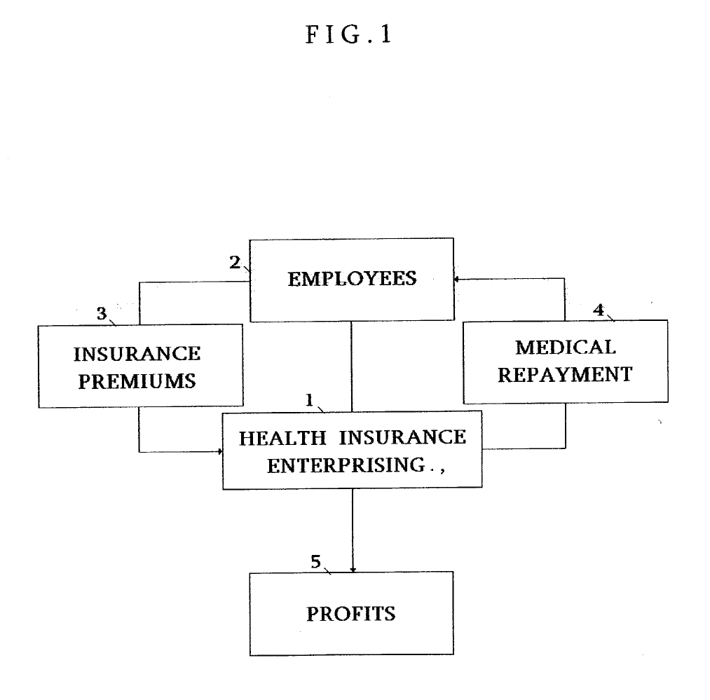

FIG. 1: The policy will create Health Insurance Enterprising Department 1 to be handled at and by enterprises, manufacturers, companies, organizations, agencies for their own employees 2.

Employees should have health insurance cards or personal insurance numbers to be provided by their own employer as insurance company and monthly premiums will directly be paid by employees from their pay check accounts.

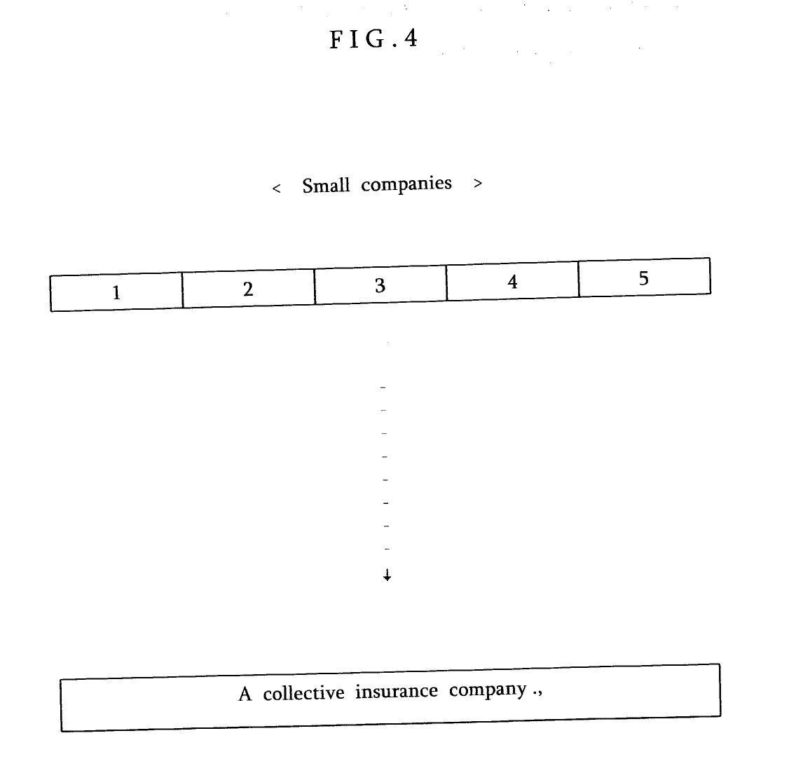

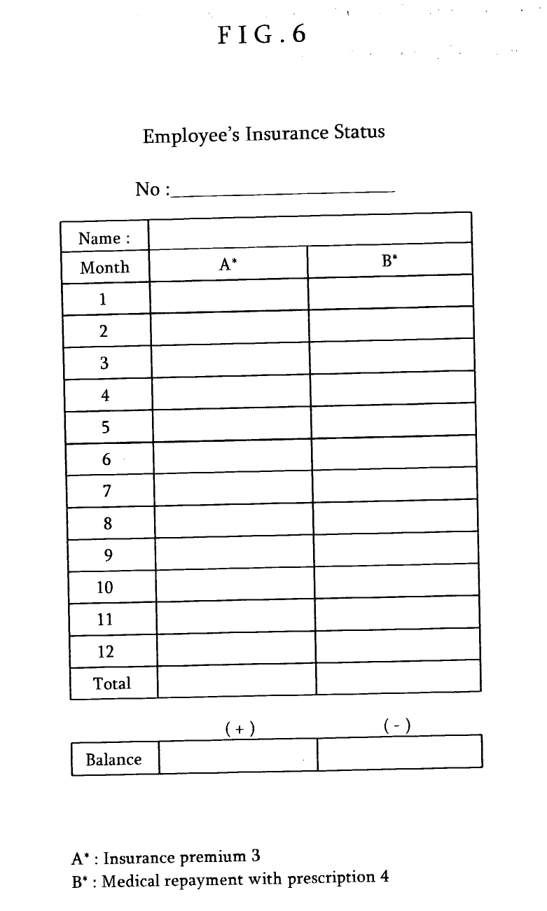

FIG. 3: It illustrates profit of the project on an annual report in which “A” represents profit earned from each employee, if a company has 100 employees, its profits will be $90,000 per year. There are 3 million US state employees, its annual profits will be around US$2,7 billions on the same basis. FIG. 6: Employee's status including insurance premiums 3 as well as medical repayment with prescription 4 has to be indicated in an individual record.

1-3. (canceled)

4. What I claim as my invention is: Enterprises, manufacturers, companies, organizations, agencies, supermarkets, associations, business groups handle health (mutual) insurance for their own employees as their business, including:
all business companies with employees,
insurance business of all sorts in said manufacturers, companies, etc,
these employers handling insurance business to their own employees under same/other names and addresses of companies.
Enterprises, manufacturers, companies, organizations, agencies, supermarkets, associations, business groups handle health (mutual) insurance for their own employees referring to claim 4, wherein employers as insurers include their owners and/or shareholders:
Enterprises, manufacturers, companies, organizations, agencies, supermarkets, associations, business groups handle health (mutual) insurance for their own employees referring to claim 4, wherein employers as insurers include their family members and/or relatives of owners.
Enterprises, manufacturers, companies, organizations, agencies, supermarkets, associations, business groups handle health (mutual) insurance for their own employees referring to claim 4, wherein employers as insurers include their family members and/or relatives of shareholders.
Enterprises, manufacturers, companies, organizations, agencies, supermarkets, associations, business groups handle health (mutual) insurance for their own employees referring to claim 4, wherein employers as insurers include their authorized insurance executors and/or associate members of owners.
Enterprises, manufacturers, companies, organizations, agencies, supermarkets, associations, business groups handle health (mutual) insurance for their own employees referring to claim 4, wherein employers as insurers include their authorized insurance executors and/or associate members of shareholders.
Enterprises, manufacturers, companies, organizations, agencies, supermarkets, associations, business groups handle health (mutual) insurance for their own employees referring to claim 4, wherein employers as insurers include their substitutes in any forms and/or under any arrangement without using employers' names of same status.
Enterprises, manufacturers, companies, organizations, agencies, supermarkets, associations, business groups handle health (mutual) insurance for their own employees referring to claim 4, wherein employees as insured and their proper employers as insurer.
Enterprises, manufacturers, companies, organizations, agencies, supermarkets, associations, business groups handle health (mutual) insurance for their own employees referring to claim 4, wherein both employees and employers function as both insured and insurer sharing profits.
Enterprises, manufacturers, companies, organizations, agencies, supermarkets, associations, business groups handle health (mutual) insurance for their own employees referring to claim 4, wherein employees that includes whole or a part of employees.
Enterprises, manufacturers, companies, organizations, agencies, supermarkets, associations, business groups handle health (mutual) insurance for their own employees referring to claim 4, wherein including exchange of employers and employees among them under any forms as “a” company takes employees of “b” company, of “a b” companies, of “b c” companies, etc as insured.
Enterprises, manufacturers, companies, organizations, agencies, supermarkets, associations, business groups handle health (mutual) insurance for their own employees referring to claim 4, wherein it includes collective insurance companies under function of these employers to employees of any companies among them.
Enterprises, manufacturers, companies, organizations, agencies, supermarkets, associations, business groups handle health (mutual) insurance for their own employees referring to claim 4, wherein it includes health insurance policies, cards, function, necessary requirement of insurance offices using same or other names.
Enterprises, manufacturers, companies, organizations, agencies, supermarkets, associations, business groups handle health (mutual) insurance for their own employees referring to claim 4, wherein insured who pays insurance premium to obtain health care coverage from insurer of companies they work.
Enterprises, manufacturers, companies, organizations, agencies, supermarkets, associations, business groups handle health (mutual) insurance for their own employees referring to claim 4, wherein insurance premium will be collected timely or monthly from employees.
Enterprises, manufacturers, companies, organizations, agencies, supermarkets, associations, business groups handle health (mutual) insurance for their own employees referring to claim 4, wherein health care coverage includes reimbursement of medical, medicine, doctor and hospital bills to insured.
Enterprises, manufacturers, companies, organizations, agencies, supermarkets, associations, business groups handle health (mutual) insurance for their own employees referring to claim 4, wherein insurance policies include health care coverage with or without employees' family members.

5. What I claim as my invention is: Enterprises, manufacturers, companies, organizations, agencies, supermarkets, associations, business groups handle employee insurance for their own employees, wherein it includes employees' insurance of all sorts; automobile and housing insurance with insurance policies, cards, premium, reimbursement, function, necessary insurance requirement functioning by their employers to employees.
Enterprises, manufacturers, companies, organizations, agencies, supermarkets, associations, business groups handle similar insurance financial business of employers to employees, wherein it consists of financial business of all sorts; opening employees' accounts for savings or similar savings projects; gathering savings capital to their employers and earning interest for employees.
Enterprises, manufacturers, companies, organizations, agencies, supermarkets, associations, business groups handle employee insurance and financial business of all sorts from employers to employees referring to claim 5, wherein their scope of protection refers to the whole elements and composition written in claim 4.
Enterprises, manufacturers, companies, organizations, agencies, supermarkets, associations, business groups handle employee insurance and financial business of all sorts from employers to employees referring to claim 5, wherein it includes doing the same or similar business under same/other names and addresses of companies of same status.

6. What I claim as my invention is: Employees' insurance & financial business to employees as clients functioning by employers as owners of their enterprises, manufacturers, companies, organizations, agencies, business groups, associations, supermarkets, business groups with employees referring to claim 4, claim 5 and claim 6, wherein the elements, composition, structures, function of the systems in any forms, process of making, contents, illustrations, of the invention, any other structures, modifications, replacement of language performing same or similar projects referring to their original fundamentals to the same effect and/or combining the invention with any other insurance, projects or systems having similar outcome under same circumstances using other names are in the scope of the protection of the invention, the invention using everywhere.
